(19) United States
(12) Patent Application Publication
(10) Pub. No.: US 2019/0372755 A1
(43) Pub. Date: Dec. 5, 2019

(54) SYSTEM AND METHOD FOR RECORDING CHANGING STANDARDS USING BLOCKCHAIN

(71) Applicant: Wilmington Trust, N.A., Wilmington, DE (US)

(72) Inventor: Patrick Tadie, East Windsor, NJ (US)

(73) Assignee: Wilmington Trust, N.A., Wilmington, DE (US)

(21) Appl. No.: 15/991,467

(22) Filed: May 29, 2018

(51) Int. Cl. H04L 9/06; G06F 17/30; G06Q 20/38

(52) U.S. Cl. CPC H04L 9/0643; H04L 2209/38; G06Q 20/382; G06F 17/30312

(57) ABSTRACT

Systems, methods, and computer-readable storage media for recording changing standards within a blockchain. A system configured to perform the method can receive, at a processor configured to read from and write to a blockchain, a request to create a new block associated with an item for the blockchain. The system retrieves, from a database, the standard for the item. The system also generates a new block of data associated with the item, the new block of data comprising: an identification of the item; at least one of the standard for the item, a hash of the standard, and a reference to the standard for the item; and a previous block hash identifying a previous block in the blockchain. The system adds the new block of data to the blockchain, to yield a modified blockchain and distributes the modified blockchain to a distributed ledger.

### BACKGROUND

### 1. Technical Field

The present disclosure relates to an implementation of blockchain technology, and more specifically to how blockchain technology can be implemented to improve accuracy in environments with dynamic standards.

### 2. Introduction

Blockchain technology allows a growing list of data, grouped into “blocks,” to be linked together and secured using cryptography. This list of data (the “blockchain”) is difficult to modify and can require keys to add and/or view the data recorded on the blockchain. In addition, many blockchains use a distributed ledger, where copies of the list are distributed to multiple nodes, and where various combinations of the multiple nodes are required to approve any addition of new blocks to the blockchain. Use of blockchain technology has been proposed and/or implemented in areas such as cryptocurrencies, supply chain management, real estate record keeping, and many others.

### SUMMARY

An exemplary method configured according to the concepts disclosed herein can include: receiving, at a processor configured to read from and write to a blockchain, a request to create a new block associated with an item for the blockchain; retrieving, at the processor from a database, a standard for the item; generated, via the processor, a new block of data associated with the item, the new block of data comprising: an identification of the item; at least one of the standard for the item, a hash of the standard, and a reference to the standard for the item; and a previous block hash identifying a previous block in the blockchain; adding, via the processor, the new block of data to the blockchain, to yield a modified blockchain; and distributing, from the processor, the modified blockchain to a distributed ledger.

An exemplary system configured according to the concepts disclosed herein can include: a processor configured to read from and write to a blockchain; and a computer-readable storage medium having instructions stored which, when executed by the processor, cause the processor to perform operations comprising: receiving a request to create a new block associated with an item for the blockchain; retrieving, from a database, a standard for the item; generated a new block of data associated with the item, the new block of data comprising: an identification of the item; at least one of the standard for the item, a hash of the standard, and a reference to the standard for the item; and a previous block hash identifying a previous block in the blockchain; adding the new block of data to the blockchain, to yield a modified blockchain; and distributing the modified blockchain to a distributed ledger.

An exemplary non-transitory computer-readable storage medium configured as disclosed herein can include instructions which, when executed by a computing device, cause the computing device configured to read from and write to a blockchain to perform operations which can include: receiving a request to create a new block associated with an item for the blockchain; retrieving, from a database, a standard for the item; generated a new block of data associated with the item, the new block of data comprising: an identification of the item; at least one of the standard for the item, a hash of the standard, and a reference to the standard for the item; and a previous block hash identifying a previous block in the blockchain; adding the new block of data to the blockchain, to yield a modified blockchain; and distributing the modified blockchain to a distributed ledger.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of linked blocks in a blockchain;

FIG. 2 illustrates exemplary distinct blockchains for distinct items;

FIG. 3 illustrates an exemplary single blockchain for distinct items;

FIG. 4 illustrates an exemplary block having standard information within a blockchain;

FIG. 5A illustrates an example of a new item being added with a corresponding standard;

FIG. 5B illustrates an example of identifying a standard for an item from multiple standards;

FIG. 6 illustrates an exemplary method embodiment; and

FIG. 7 illustrates an exemplary computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Producing quality items requires testing those items against standards. Moreover, as the complexity of the item increases, the amount of testing required for that item can also increase. For example, a company producing bags of gravel may need to test the item's weight. Likewise, a company producing an automobile tire may need to test how the tire reacts under various temperatures, pressures, abrasive surfaces, etc. However, regardless of the complexity of the item and its respective testing, the standard for testing a given product must be predefined to ensure product quality.

However it can be difficult to determine what the original standard was, or how the original testing of the item was conducted, if the item later fails. For example, if an item is created, tested to a standard, and then fails years later, it can be critical from a design and/or legal perspective to determine the cause of the failure. While part of that analysis can be a review of the circumstances at the time of failure, another part of that analysis can be a review of the original testing and standards at the time of product creation.

In some cases, retrieving the original testing data and standards from the time of item creation is performed using a database. For example, if a video game console is produced and tested against a standard, a database can be used to record the console's serial number, its initial test data, and the standard used for the testing. If the console were to break, the manufacturer could look up, for that serial number, the initial testing data and the standard to which it was tested.

However, databases can have accuracy issues, specifically when the database can be altered or otherwise manipulated. While a single, private company might be able to maintain accuracy over a database containing information about that company's products, databases cannot be entirely trusted in situations such as where products are being created by multiple vendors, or where the database(s) are accessible or otherwise capable of being manipulated by multiple entities. For example, in a supply chain, data about the product can be forwarded up the supply chain, but if that data is stored in a database it can potentially be manipulated, and render the data questionable or inaccurate.

Blockchain technology, modified as disclosed herein, can be used to record testing and/or standard data associated with specific products in an immutable ledger, thereby providing for improved security and accuracy over previous data storage systems. In the event of an item later failing, the testing data and/or standard data originally recorded for that item can then be readily retrieved from the blockchain. In some configurations, the testing data and/or standard data originally recorded can then be used to determine fault or fault attribution of the item failing.

Consider the following example of testing data and associated standards being included in a blockchain for a supply chain. In this example, an end product is produced by an end manufacturer using multiple components produced by distinct component manufacturers. Often in supply chains, two separate standards for each component may be applicable: the standard of the end manufacturer and an internal standard unique to each distinct component manufacturer. In other cases, a single standard may be used by the end manufacturer and the multiple component manufacturers, but how the single standard is applied or tested may vary between the component manufacturers. However, regardless of the number of standards or how they are applied, when the end product breaks, a culpability analysis will need to be performed to determine why the end product broke and who should bear the ultimate responsibility for that failure.

With previously-used database systems, the end manufacturer may be able to retrieve a serial number or other identification identifying which component manufacturer produced a faulty component. However, the end manufacturer may not be able to trust that the data hasn't been modified or altered since the original recording. Also, if the data is old, or not readily accessed, retrieval speed may deteriorate. In addition, assuming the component manufacturer has the data, the overall timing of the data retrieval system can be relatively slow because of the time required to identify the entity which manufactured the component, send a request for the data, receive a response from the component manufacturer, and process the response.

By contrast, a system configured as disclosed herein can utilize a blockchain to record information component data, testing data regarding how the component compared to a standard, the standard itself, etc. In one configuration, a single blockchain stored across multiple devices (a distributed ledger) is used to keep track of multiple items and components, such that each time a new item is generated, the manufacturer of that particular item adds a block to the blockchain. The newly added block can contain information such as the component serial number, the standard to which the component was tested, the testing data itself, as well as blockchain data (previous block hash, current hash identifier, etc.). By storing the data in a distributed ledger, the bandwidth requirements when component data needs to be looked up can be reduced, while the speed of retrieval is increased because the entity already contains a copy of the blockchain. This allows a computer system to process more transactions in a shorter amount of time.

In another configuration, each physical component generated forms a new blockchain using previous blocks or blockchains from the physical materials or physical sub-components used to generated the physical component. These newly formed blockchains can combine the previous blocks or blockchains together, while also including the standards and testing data for the newly generated physical component as well as the standards and testing data for the sub-components. In this manner, standards and testing data for each subcomponent in a given object can be recorded, and when a fault occurs in the object a comparison of the testing data to the standards at time of manufacturer can be re-evaluated.

As another example, consider the business of loan generation and loan sales. When a lender generates a loan, the lender tests the borrower's ability to pay back the loan using underwriting standards. If the borrower's information meets the underwriting standards, the lender will issue the loan and begin collecting payments on the loan. For various reasons (such as faster access to capital, non-performance, etc.), the lender may wish to sell the loan, or a right to collect the payments from the loan, as a note to another entity. In this manner, notes can pass from entity to entity. However, if the borrower ever stops paying on the loan, the loan will go into default.

If the loan was secured for a house, this could mean foreclosure; if the loan were secured for a car, repossession is possible; if the loan was unsecured, other actions may be possible. However, if the note for the loan has passed between multiple entities, contractual terms may exist between those entities based on representations made about the note, and specifically the borrower's ability to pay on the note. In other words, the holder of the note when the borrower stops paying may have an option to collect damages from the previous seller of the note, based on the representations made.

To ultimately determine if the note was made and/or sold in good faith, or if the default could have been predicted at origination, the original underwriting standards need to be retrieved along with the original information about the borrower. Because time has passed, the underwriting standards may have changed. That is, new loans may be issued using updated/different underwriting standards than when this loan was originally issued. Moreover, because the note has been passed between multiple entities, classical databases cannot guarantee that the data being retrieved has not been modified or corrupted, and that the data accurately represents the borrower at the time the loan was issued. The problem (rooted in computer technology) of a slow retrieval of database records, accuracy of database records, confidence that the records have not been modified or corrupted, etc., can be solved using the solutions disclosed herein.

To remedy this problem, the original underwriting standard, how the borrower compared to that standard (i.e., test data), and other data associated with the loan can be stored in a blockchain configured as disclosed herein. For example, as a borrower requests a loan, the lender can retrieve current underwriting standards, determine if the borrower meets those standards, and if so authorize the loan. At that point, the lender can generate a new block to be added to a blockchain stored as a distributed ledger by multiple entities. The lender can submit the new block for the new loan to the multiple entities, which can review the new block, information about the lender submitting the new block, etc., and determine if the new block should be added to the blockchain. Upon determining that yes, the new block should be added to the blockchain (consensus), the block is added to the blockchain and the updated blockchain is distributed to the various entities storing the distributed ledger. As the loan is sold, packaged with other loans, etc., the blockchain can be updated with additional blocks containing details about the loan.

Later, when one of the entities storing (or having access to) the distributed ledger detects that the loan has gone into default, that entity can access the block generated by the original lender. Specifically, the original underwriting standard can be retrieved, the borrower data and/or comparison to the standard (i.e., the test data), and any other data about the loan can be retrieved. In some configurations, the entity can then perform an automated review of the test data and the original underwriting standard to verify that the loan was properly originated.

The examples provided above are particularly applicable in circumstances where the standard may change. For example, with a supply chain the standard to which a component is tested may change every six months, while underwriting standards may change every two months. In such circumstances, storing the standard and the testing data within a blockchain can speed up the ability to retrieve the data, while simultaneously adding additional security and accuracy because only certain parties can add blocks to the blockchain and once added the data is immutable. In yet another example, the principles disclosed herein can be applied to circumstances where the standard is relatively stable, but the testing procedure can vary greatly.

Consider the example of a security check at an airport. The security standard to which passengers and their belongings should be scanned and checked may be static for a given day, but the degree of scrutiny given to a given passenger and/or their belongings may vary based on the particular security agent performing the security check. For example, a first security officer reviewing X-ray images may be particularly detailed in their inspection, and a second security officer (who sometimes replaces the first security officer) may be less detailed. While both officers should be testing to the same standard, how they test may vary.

The solutions described herein can be applied in this example by generating, for each passenger, a block which is added to a blockchain. The newly generated block can contain information such as the identification of the security agent, an identification of a passenger, a current standard to which the passenger is being screened, and testing data about the performance of the security agent. Later, if there is an issue with a particular passenger, or a particular security agent, a record of the security agent's performance relative to the standard can retrieved from the blockchain. Unlike a database, this record can be secured through asymmetrical encryption, can be stored on a distributed ledger, and can be readily retrieved due to its distributed nature.

Having provided the above examples, the disclosure next turns to the figures. Aspects of any given configuration or embodiment described herein can be applied to, or removed from, any described configuration or embodiment.

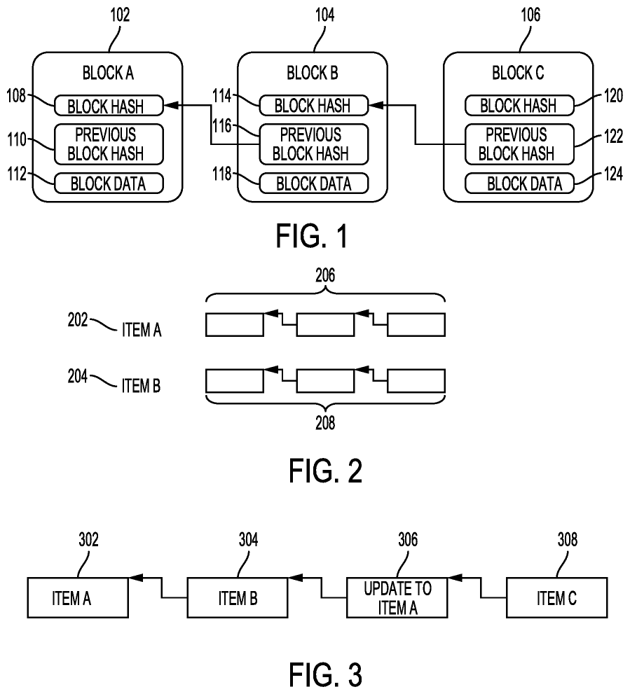

FIG. 1 illustrates an example of linked blocks 102, 104, 106 in a blockchain. Each block 102, 104, 106 contains information associated with respective items, and each respective block 102, 104, 106 contains information about the respective item associated with each block. The blocks 102, 104, 106 are chained together by referring, or pointing, to the previous block.

For example, block A 102 is associated with a product, item, or object. Within block A 102 is block data 112, such as identification information about the product, item, or object, standard information about how the product was tested, testing data regarding how the product compared to the standard at origination, etc. The block 102 also contains a reference to the previous block in the blockchain in the form a previous block hash 110, and a hash function output 108 of the current block. The block hash 108 is the output of a hash function (such as, but not limited to, SHA-256) which takes the content of the block 102 as input, then produces an output of fixed length. The previous block hash 110 identifies the hash function output of the previous block, thereby identifying which block directly precedes the current block. While some basic hash functions may be capable of performance by humans, either mentally or with pen and paper, hash functions as described herein explicitly exclude such human-being capable hash functions.

Block B 104 and block C 106 likewise contain block data 118, 124, block hashes 114, 120, and references to the previous block hash 116, 122. Thus, block B 104 contains a previous block hash 116 which is the same value as the block hash 108 of block A 102. Likewise, block C 106 contains a previous block hash 122 which is the same value as the block hash 114 of block B 104.

FIG. 2 illustrates exemplary distinct blockchains for distinct items. In this example, each item 202, 204 (a loan, a component, a person, etc.) causes generation of a separate blockchain 206, 208. Therefore, in this example, when item A 202 is created, the blockchain 206 for item A 202 is created, with new blocks being added to the blockchain 206 based on sales, transfers, updates, or other interactions with item A 202. Likewise, when item B 204 is created, the blockchain 208 for item B 204 is created, with new blocks added to the blockchain 208 based on interactions with item B 204. In otherwords, FIG. 2 illustrates that there can be distinct blockchains for each product, component, or other item within a system. This can be useful in minimizing the amount of data being stored on a system because, as items are consumed or otherwise exhausted, the corresponding blockchain of the item can be deleted. Likewise, in scenarios where data needs to be closely guarded, greater security can be provided to the data by only transferring or sharing blocks of data which are pertinent to a given situation. By having separate blockchains for each item, the system can provide only the blocks and blockchains needed in a given scenario (rather than all blockchain data for all items).

FIG. 3 illustrates an exemplary single blockchain for distinct items. In this example, there exists only a single blockchain which can be stored on multiple computer systems as a distributed ledger. As each item is generated, added, or otherwise interacted with, the system can generate a new block and add that block to the blockchain.

For example, as illustrated the blockchain contains a block 302 describing item A. The item A block 302 can contain the block's hash, a hash number of the previous block, block data, etc. Next, the illustrated blockchain contains a block 304 describing item B, which can likewise contain the block's hash, a hash number of the previous block 302, block data, etc. The next block 306 in the blockchain is an update to the information stored in the first block 302 regarding item A. This could be because item A was retested against another standard, sold, or otherwise interacted with. Finally, the illustrated blockchain contains a block 308 regarding an item C.

A singular blockchain can have advantages regarding immediate access to information by all nodes. That is, as the blockchain receives new blocks and is updated, the new, modified blockchain will be disbursed among all nodes in the system, such that when any one of the nodes in the system has a need to access information about any respective item, the node can immediately access that information using the blockchain already stored in memory at the node.

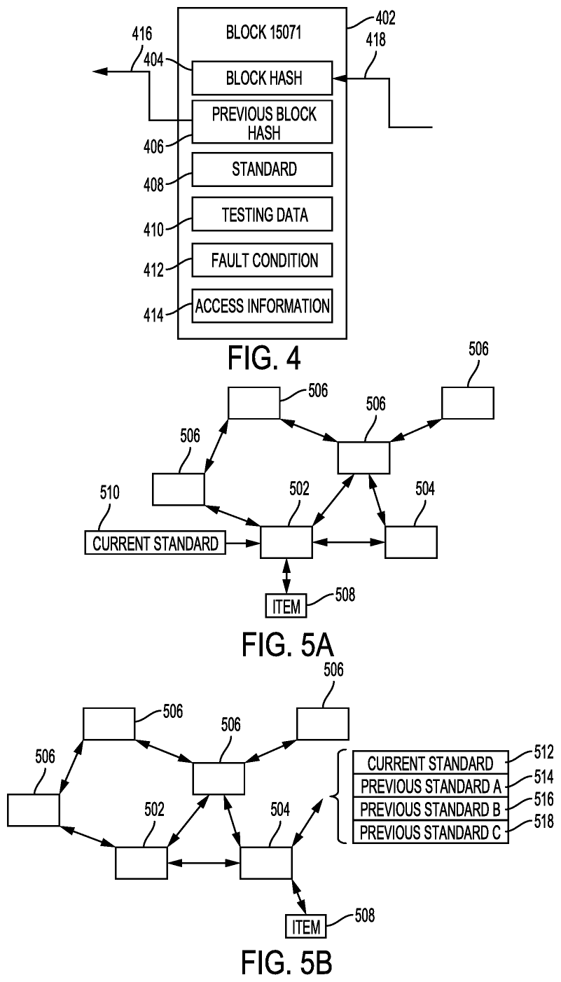

FIG. 4 illustrates an exemplary block 402 having standard information within a blockchain. This exemplary block 402 contains data described above, such as the block hash 404 and the previous block hash 406. The previous block hash 406 refers 416 to the hash of the previous block in the blockchain, whereas the block hash 404 is referred to by the subsequent block in the blockchain.

Additional block data which can be contained in blocks configured according to this disclosure can include a standard 408 to which the real-world item was tested or compared, the testing data 410 of that testing or comparison, conditions which would cause the item to be considered “in fault” 412, and access information 414 providing requirements/restrictions on who can read the data contained within the block 402.

In some configurations, the fault condition data 412 can be used as part of a smart contract, such that as data regarding the item is received, it can be compared to the fault condition data 412, and the processor performing the comparison can determine that the fault has occurred. Likewise, when a fault has occurred, in some configurations the processor can be configured to re-evaluate the testing data 410 based on the standard 408. This re-evaluation can allow the processor to determine if the item should have passed the initial quality control test at the time of creation. To perform such an evaluation, the processor must be configured to be able to read from the blockchain, which can be restricted. The access information 414 can limit who can read from the blockchain or individual blocks within the blockchain. In some configurations, this access is limited by requiring a public or private key (i.e., codes used as part of asymmetrical encryption), whereas in other configurations the access is granted based on user information.

FIG. 5A illustrates an example of a new item 508 being added with a corresponding standard 510. In this example, there are multiple nodes 502, 504, 506 in a network which can exchange information regarding items using a distributed ledger, such as a blockchain. When one of the nodes 502 detects a new item 508, the node 502 can retrieve the current standard 510 for quality control of that item. The node 502 performs a test using the standard 510 and the item to determine if the new item should be added to an inventory, a collection, or other list of items. If the item passes the test, a block containing (1) information about the item and/or (2) information regarding the standard, is added to the blockchain, then the updated blockchain is communicated to the other nodes 504, 506 in the network. The information regarding the standard can be the standard itself, a code referencing the current standard, a link to the standard, and/or a hash output of the standard.

FIG. 5B illustrates an example of identifying a standard for an item 508 from multiple standards 512-518. After the item information has been added as a block in the blockchain, and the updated blockchain has been communicated to the other nodes 504, 506 within the network, a fault may be detected in the item 508. This fault may be detected by the node 502 which generated the block for the item 508, or it may be detected by another node. As illustrated, the fault is detected by a distinct node 504. The node 504 may have access to multiple standards 512-518, including the current standard 512 and previous standards 514, 516, 518. Accessing the blockchain record, the node 504 can determine which of the standards was used when the item's 508 block record was created, then use that standard to determine if there was an error in the original testing of the item 508.

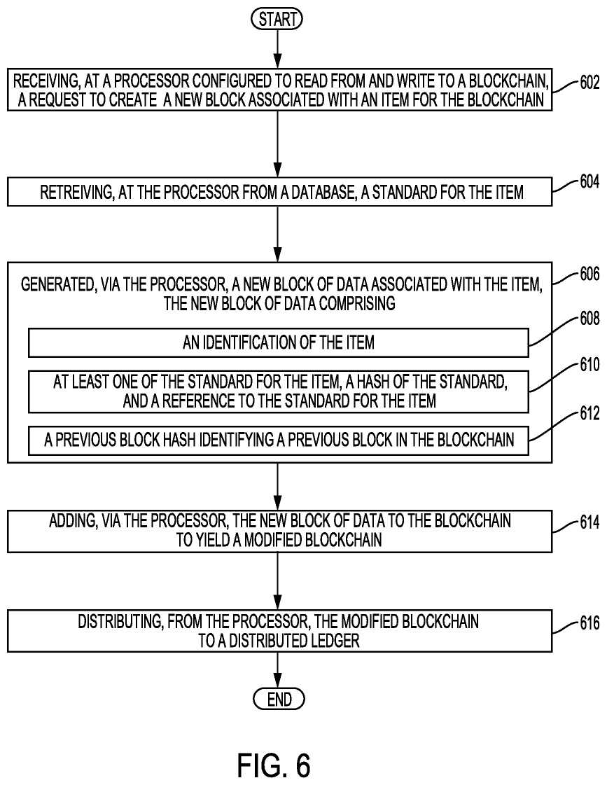

FIG. 6 illustrates an exemplary method embodiment. The steps outlined herein are exemplary and can be implemented in any combination thereof, including combinations that exclude, add, or modify certain steps. A system configured to perform the method can receive, at a processor configured to read from and write to a blockchain, a request to create a new block associated with an item for the blockchain (602). The item can be anything to which a standard for compliance exists, such as a manufacturing standard for a product or component, an underwriting standard for a loan, a protocol standard for a security check, etc. The system retrieves, at the processor from a database, the standard for the item (604). The system also generates, via the processor, a new block of data associated with the item, the new block of data (606) comprising: an identification of the item (608); at least one of the standard for the item, a hash of the standard, and a reference to the standard for the item (610); and a previous block hash identifying a previous block in the blockchain (612). The system adds, via the processor, the new block of data to the blockchain, to yield a modified blockchain (612) and distributes, from the processor, the modified blockchain to a distributed ledger (614).

In some configurations, the system can create an association between particular pieces of data and stores those associations. Later, when a condition is met based on a first piece of data, additional triggers or processes can be initiated based on the associations of that first piece of data to other pieces of data.

In some configurations, the new block of data can further include data/information such as: at least one of testing data comparing the item to the standard, a hash of the testing data, and a reference to the testing data; and a fault condition for the item. In such configurations, the method can be augmented to include receiving a notification of a fault with the item based on the fault condition and, based on the notification, performing an additional comparison of the item to the standard, the additional comparison identifying if the fault could have been predicted based on the testing data. Likewise, the method may be augmented to include receiving a current status of the item and performing an additional comparison of the item to the standard based on the current status.

When the item is a physical component, product, or retail item, the standard can be the physical standards of the physical component. If the item is a loan, the standard can be the underwriting guidelines for the loan.

The testing data can provide information about the item and how the item compared to the standard, satisfied tests associated with the standard, and/or otherwise was identified as satisfactory/non-satisfactory according to the standard.

The ability to read data stored within the distributed ledger can be limited or freely available based on access information stored within a given block. Likewise, the ability to add new blocks of data, or otherwise modify the blockchain, can similarly be restricted. The ability to modify data already contained within blocks can also be limited to reduce forking of the blockchain. The rights to read, add, or modify blocks in the blockchain can be restricted using public and/or private keys, or other aspects of asymmetrical cryptography.

When a failure is detected in the item, the system can retrieve the standard and the testing data. In some configurations, the standard and the testing data can be forwarded to a person conducting a review of the failure. Preferably, however, the system can use the public/private keys to automatically retrieve the testing data and standard from the blockchain, then perform an updated comparison of the testing data to the standard to make an automatic determination if the item should have been allowed under the original standard.

The use of a distributed ledger, or blockchain, can provide a backup to data which is corrupted. If, for example, the blocks were sequentially stored in a single database, and part of the database were damaged or altered, there might be no recovery of the data. Because the copies of the distributed ledger are stored on multiple nodes or devices, if any single node is damaged or destroyed the full record can still be recovered. Likewise, use of a distributed ledger can speed up the computing system by operating as a cache for the individual nodes, allowing each individual node to access data from the blockchain faster than if the node needed to transmit a request and receive a response to the request.

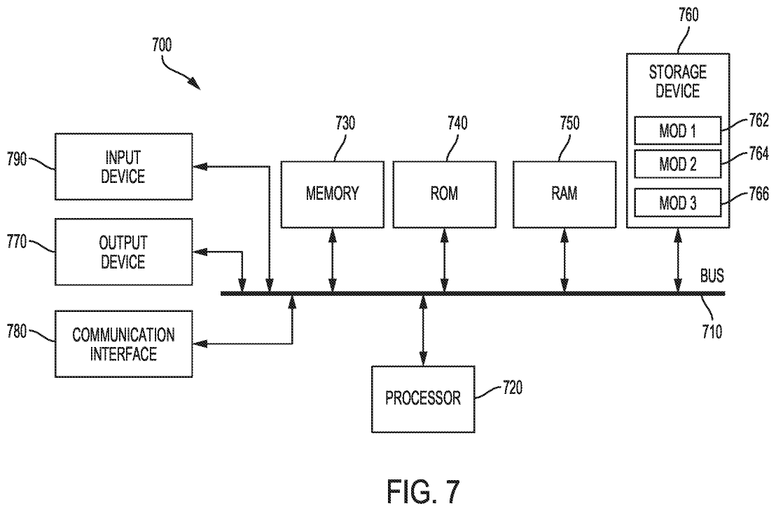

With reference to FIG. 7, an exemplary system includes a general-purpose computing device 700, including a processing unit (CPU or processor) 720 and a system bus 710 that couples various system components including the system memory 730 such as read-only memory (ROM) 740 and random access memory (RAM) 750 to the processor 720. The system 700 can include a cache of high-speed memory connected directly with, in close proximity to, or integrated as part of the processor 720. The system 700 copies data from the memory 730 and/or the storage device 760 to the cache for quick access by the processor 720. In this way, the cache provides a performance boost that avoids processor 720 delays while waiting for data. These and other modules can control or be configured to control the processor 720 to perform various actions. Other system memory 730 may be available for use as well. The memory 730 can include multiple different types of memory with different performance characteristics. It can be appreciated that the disclosure may operate on a computing device 700 with more than one processor 720 or on a group or cluster of computing devices networked together to provide greater processing capability. The processor 720 can include any general purpose processor and a hardware module or software module, such as module 1 762, module 2 764, and module 3 766 stored in storage device 760, configured to control the processor 720 as well as a special-purpose processor where software instructions are incorporated into the actual processor design. The processor 720 may essentially be a completely self-contained computing system, containing multiple cores or processors, a bus, memory controller, cache, etc. A multi-core processor may be symmetric or asymmetric.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up. The computing device 700 further includes storage devices 760 such as a hard disk drive, a magnetic disk drive, an optical disk drive, tape drive or the like. The storage device 760 can include software modules 762, 764, 766 for controlling the processor 720. Other hardware or software modules are contemplated. The storage device 760 is connected to the system bus 710 by a drive interface. The drives and the associated computer-readable storage media provide nonvolatile storage of computer-readable instructions, data structures, program modules and other data for the computing device 700. In one aspect, a hardware module that performs a particular function includes the software component stored in a tangible computer-readable storage medium in connection with the necessary hardware components, such as the processor 720, bus 710, display 770, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 700 is a small, handheld computing device, a desktop computer, or a computer server.

Although the exemplary embodiment described herein employs the hard disk 760, other types of computer-readable media which can store data that are accessible by a computer, such as magnetic cassettes, flash memory cards, digital versatile disks, cartridges, random access memories (RAMs) 750, and read-only memory (ROM) 740, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A method of adding information about an item and a first standard corresponding to the item to a blockchain distributed in a network comprising a plurality of nodes, the method comprising:
detecting the item at a first node of the plurality of nodes;
retrieving the first standard for the item from a database via a processor configured to read from and write to a blockchain, the database storing at least the first standard;
comparing the item to the first standard, resulting in a first comparison;
when the first comparison indicates that the item meets the first standard, generating a first block of data associated with the item via the processor, the first block of data comprising:
an identification of the item;
the first standard for the item;
a first block hash associated with the first block; and
a previous block hash identifying a previous block in the blockchain;
adding, via the processor, the first block of data to the blockchain, to yield a modified blockchain;
distributing the modified blockchain to the plurality of nodes other than the first node, via the processor;
detecting a first fault with the item via one of the nodes of the plurality of nodes, the first fault indicating a failure of the item to meet the first standard;
based on the first fault, retrieving the first standard from the modified blockchain, via the processor;
comparing the first standard from the modified blockchain with the item, via the processor, to yield a second comparison; and
determining, via the processor if the first fault could have been predicted based on the second comparison.

2. The method of claim 1, wherein the first block of data further comprises:
at least one of testing data comparing the item to the first standard, a hash of the testing data, and a reference to the testing data; and
a fault condition for the item.

3. (canceled)

4. The method of claim 2, further comprising:
receiving a current status of the item; and
performing an additional comparison of the item to the first standard based on the current status.

5. The method of claim 1, wherein the item comprises a physical component, and the first standard comprises physical standards of the physical component.

6. The method of claim 1, wherein the item comprises a loan, and the first standard comprises underwriting guidelines for the loan.

7. The method of claim 1, wherein the first block of data further comprises access information, the access information identifying a key necessary to read and modify the first block.

8. A system for adding information about an item and a first standard corresponding to the item to a blockchain distributed in a network comprising a plurality of nodes, the system comprising:
a processor configured to read from and write to the blockchain, the blockchain storing multiple standards; and
a non-transitory computer-readable storage medium having instructions stored which, when executed by the processor, cause the processor to perform operations comprising:
detecting the item at a first node of the plurality of nodes;
retrieving the first standard for the item from a database storing at least the first standard;
comparing the item to the first standard, resulting in a first comparison;
when the first comparison indicates that the item meets the first standard, generating a first block of data associated with the item, the first block of data comprising:
an identification of the item;
the first standard for the item;
a first block hash associated with the first block; and
a previous block hash identifying a previous block in the blockchain;
adding the first block of data to the blockchain, to yield a modified blockchain;
distributing the modified blockchain to the plurality of nodes other than the first node;
detecting a first fault with the item via one of the nodes of the plurality of nodes, the first fault indicating a failure of the item to meet the first standard;
based on the first fault, retrieving the first standard from the modified blockchain;
after retrieving comparing the first standard from the modified blockchain with the item to yield a second comparison; and,
determining if the fault could have been predicted based on the second comparison.

9. The system of claim 8, wherein the first block of data further comprises:
at least one of testing data comparing the item to the first standard, a hash of the testing data, and a reference to the testing data; and
a fault condition for the item.

10. (canceled)

11. The system of claim 9, the non-transitory computer-readable storage medium having additional instructions stored which, when executed by the processor, cause the processor to perform operations comprising:
receiving a current status of the item; and
performing an additional comparison of the item to the first standard based on the current status.

12. The system of claim 8, wherein the item comprises a physical component, and the first standard comprises physical standards of the physical component.

13. The system of claim 8, wherein the item comprises a loan, and the first standard comprises underwriting guidelines for the loan.

14. The system of claim 8, wherein the first block of data further comprises access information, the access information identifying a key necessary to read and modify the first block.

15. A non-transitory computer-readable storage medium having instructions stored which, when executed by a computing device configured to read from and write to a blockchain storing multiple standards, cause the computing device to perform operations for adding information about an item and a first standard corresponding to the item to the blockchain distributed in a network comprising a plurality of nodes comprising:
detecting the item at a first node of the plurality of nodes;
retrieving the first standard for the item from a database storing at least the first standard;
comparing the item to the first standard, resulting in a first comparison;
when the first comparison indicates that the item meets the first standard, generating a first block of data associated with the item, the first block of data comprising:
an identification of the item;
the first standard for the item;
a first block hash associated with the first block; and
adding the first block of data to the blockchain, to yield a modified blockchain;
distributing the modified blockchain to the plurality of nodes other than the first node;
detecting a first fault with the item via one of the nodes of the plurality of nodes, the first fault indicating a failure of the item to meet the first standard;
based on the first fault, retrieving the first standard from the modified blockchain;
after retrieving comparing the first standard from the modified blockchain with the item to yield a second comparison; and,
determining if the fault could have been predicted based on the second comparison.

16. The non-transitory computer-readable storage medium of claim 15, wherein the first block of data further comprises:
at least one of testing data comparing the item to the first standard, a hash of the testing data, and a reference to the testing data; and
a fault condition for the item.

17. (canceled)

18. The non-transitory computer-readable storage medium of claim 16, having additional instructions stored which, when executed by the computing device, cause the computing device to perform operations comprising:
receiving a current status of the item; and
performing an additional comparison of the item to the first standard based on the current status.

19. The non-transitory computer-readable storage medium of claim 15, wherein the item comprises a physical component, and the first standard comprises physical standards of the physical component.

20. The non-transitory computer-readable storage medium of claim 15, wherein the item comprises a loan, and the first standard comprises underwriting guidelines for the loan.
